(19) United States
(12) Patent Application Publication
(10) Pub. No.: US 2024/0186480 A1
(43) Pub. Date: Jun. 6, 2024

(54) MULTI-LAYER LITHIUM METAL BATTERY NEGATIVE ELECTRODE, AND PREPARATION METHOD AND PREPARATION DEVICE THEREFOR

(71) Applicant: SHENZHEN YANYI NEW MATERIALS CO., LTD., Guangdong (CN)

(72) Inventors: Min YUE, Guangdong (CN); Shiqi ZHANG, Guangdong (CN); Weijing FENG, Guangdong (CN); Kai YANG, Guangdong (CN); Chao QIAN, Guangdong (CN)

(73) Assignee: SHENZHEN YANYI NEW MATERIALS CO., LTD., Guangdong (CN)

(21) Appl. No.: 18/552,585

(22) PCT Filed: Nov. 5, 2021
(86) PCT No.: PCT/CN2021/129086

§ 371 Date: Sep. 26, 2023

(30) Foreign Application Priority Data
Mar. 26, 2021 (CN) 202110323725.4

(51) Int. Cl. H01M 4/04; H01M 4/02; H01M 4/139; H01M 4/36; H01M 10/0565

(52) U.S. Cl. CPC H01M 4/0423; H01M 4/139; H01M 4/366; H01M 10/0565; H01M 2004/027

(57) ABSTRACT

The present invention relates to a multi-layer lithium metal battery negative electrode, and a preparation method and preparation device therefor. The multi-layer lithium metal battery negative electrode comprises a current collector, a lithium metal layer, a fast ion conductor layer and a functional protection layer. The present invention also relates to a method for preparing the multi-layer lithium metal battery negative electrode, the method characterized by comprising the following steps: (1) a step of evaporating a lithium metal; (2) a step of evaporating a fast ion conductor; and (3) a step of coating a protective material and a polymer solid electrolyte. In addition, the present invention relates to a device for preparing the multi-layer lithium metal battery negative electrode. The multi-layer lithium metal battery negative electrode of the present invention utilizes the composite synergistic effect of the lithium metal layer, the fast ion conductor layer and the functional protection layer, such that the cycling performance, cycling life and safety performance of a lithium metal battery are significantly improved, and the problem of a lithium dendrite appearing in a lithium metal negative electrode is solved.

### TECHNICAL FIELD

The present application relates to the technical field of lithium batteries, and in particular to a multi-layer lithium metal battery anode and a preparation method therefor and a preparation device therefor.

### BACKGROUND

Since the first batch of lithium-ion batteries mass-produced by Sony in 1991, the “rocking-chair battery” has become the fastest-growing lithium-ion battery in the market. The energy density and specific capacity of the existing lithium-ion batteries are gradually approaching their theoretical limits. With the rapid development of portable electronic devices and electric vehicle markets, traditional carbon anodes are gradually unable to meet increasing demand for energy density, and the development for new anode materials has become the trend of the lithium battery industry in the future. Metal lithium has the lowest redox potential (−3.04 V, relative to the standard hydrogen electrode) and extremely high specific capacity (3860 mAh/g), and lithium metal anode materials have attracted considerable attention.

However, in practical applications, the high activity of lithium metal anodes brings great safety latent risk. The commercialization of lithium metal anodes is limited by the dendrite problem caused by the uneven deposition of lithium ions. The existence of lithium dendrites will increase the specific surface area to a certain extent, aggravate the interfacial side reactions, and accelerate the collapse and regeneration of the solid electrolyte interphase film (SEI film). Meanwhile, the broken irregular dendrites will become “dead lithium” without electrochemical activity, causing serious “pulverization” of the anode, increasing impedance, and reducing the cycle capacity and cycle life of lithium batteries. In addition, the continuously growing dendrites can penetrate the separator and touch the positive electrode, causing internal short circuits in the battery, and seriously affecting the practical application of lithium metal batteries.

At present, it has become a research hotspot about how to inhibit the growth of lithium dendrites and improve the stability of lithium metal anodes. Chinese patent application CN105845891A discloses a metal lithium anode with a double-layer structure. The metal lithium anode is composed of a metal lithium layer on the bottom layer and a surface covering layer on the upper layer. The surface covering layer includes one or more of a carbon material, a polymer material and a glass fiber; an electrolyte and a positive electrode material are used to assembled into a battery; the distribution of lithium ions on the surface of the anode can be regulated and the massive generation of lithium dendrites can be suppressed. However, the metal lithium anode cannot completely eliminate the influence of lithium dendrite growth, and the thickness of the surface covering layer is up to 200 μm, which will increase the internal resistance of the battery, affect the transport rate of lithium ions, and thus reduce the capacity retention rate during electrochemical cycling.

Chinese patent application CN107093705A discloses a method for preparing a solid electrolyte protection layer, specifically including dissolving salts or esters as an additive into an organic solvent to prepare an electrolyte solution; subjecting the electrolyte solution to reaction with a metal lithium sheet to form a solid electrolyte protection layer on the lithium sheet. Although the solid electrolyte protection layer has a certain inhibiting effect on lithium dendrites, the protection layer is not dense or uniform, has low mechanical strength, and contains by-products generated by the reaction between the electrolyte solution and the metal lithium sheets.

Chinese patent application CN108565398A discloses a lithium anode with an inorganic protection coating and a preparation method thereof. The inorganic protection layer is prepared by a lithium ion conductor inorganic compound or an inorganic compound that can generate a lithium ion conductor in situ on the surface of the lithium anode and a binder, facilitating uniform deposition of lithium ions and slowing down the growth of lithium dendrites. However, when the lithium dendrites grow to a certain extent, since there is no protection material to react with the lithium dendrites, the growth of the lithium dendrites cannot be further suppressed, the risk of short circuits inside the battery cannot be avoided. In addition, this patent application can only be applicable to lithium sheets; the coating method is used, and the coating thickness is large; the particle size of the inorganic compound particles is more than 50 nm; the binder content is high, leading to a decrease in ion conductivity, which is not conducive to the transport of lithium ions and degrades electrochemical performances.

According to the collaborative research of the team of Ningbo Institute of Materials Technology and Engineering and the research group of Professor Zhang Jiguang and Xu Wu of the Pacific Northwest National Laboratory, a silver-lithium fluoride artificial interphase is prepared on the surface of lithium metal based on a simple and effective ion replacement reaction (Zhe Peng, et al. “Enhanced Stability of Li Metal Anodes by Synergetic Control of Nucleation and the Solid Electrolyte Interphase”, doi: 10.1002/aenm.201901764). Lithium ions have a high adsorption capacity on the surface of silver particles, which can effectively reduce the mass transport energy barrier of lithium ions during the reduction process, realize the orderly nucleation of lithium metal during the deposition process, and avoid local dendrite growth. However, this method has some insurmountable problems, such as the high cost of the raw materials involved, the complex artificial interphase process, the low production efficiency, and the difficulty in realizing large-scale industrial production.

Therefore, in view of the problems of poor cycle stability, short service life, and poor safety of lithium metal batteries in the prior art, it is urgent to develop a new lithium metal battery anode, which can effectively avoid the growth of internal lithium dendrites, has controllable preparation process and low production cost, and is suitable for large-scale industrial production.

### SUMMARY

The technical problem to be solved by the present application is to overcome the shortcomings and deficiencies of the prior art, and a multi-layer lithium metal battery anode and a preparation method therefor and a preparation device therefor are provided.

Specifically, the present application provides the technical solutions below.

A multi-layer lithium metal battery anode includes a current collector, a lithium metal layer, a fast ionic conductor layer and a functional protection layer.

A preparation method of the multi-layer lithium metal battery anode includes the following steps:
(1) a step of depositing lithium metal via evaporation;
(2) a step of depositing a fast ionic conductor via evaporation; and
(3) a step of coating a protection material and a polymer solid electrolyte.

A device for preparing the multi-layer lithium metal battery anode is provided, which is used to implement the preparation method of the multi-layer lithium metal battery anode, including a first vacuum evaporation apparatus, a second vacuum evaporation apparatus and a conveying apparatus which are arranged in a same vacuum chamber;

wherein the first vacuum evaporation apparatus and the second vacuum evaporation apparatus independently include an evaporation tank and a temperature control unit, preferably, the first vacuum evaporation apparatus and the second vacuum evaporation apparatus independently include one evaporation tank and one temperature control unit;

the two vacuum evaporation apparatuses are equipped with a film thickness measuring apparatus;

the conveying apparatus includes a winding collection apparatus, and preferably, the winding collection apparatus includes an unwinding roller, a guide roller, a temperature control roller, a heat preservation roller, a cooling roller and a winding roller.

The present application has the beneficial effects below.

The present application provides a multi-layer lithium metal battery anode and a preparation method therefor and a preparation device therefor, which have the following advantages compared with the prior art.

(1) In the present application, the production of lithium metal anode with a multi-layer structure is continuously and integratedly completed from lithium source via the vacuum evaporation and coating processes. The vacuum evaporation process refers to a process in which an evaporation material is vaporized, evaporated or sublimated to the surface of the substrate under vacuum conditions and deposits to form a thin film by increasing the temperature. The rolling method usually cannot achieve the anode thickness provided by the present application, and even if the thickness required by the present application is achieved, the requirements for the rolling equipment are extremely strict, and thus it is obviously impossible to achieve mass production on a large scale. The multi-layer lithium metal battery anode of the present application can be adapted to most battery systems with lithium metal as the anode after a little treatment, such as lithium-sulfur (Li—S) battery system and lithium-oxygen (Li—O₂) battery system. In conclusion, the preparation process of the present application is relatively simple, the preparation process is easy to control, the cost can be saved, and the preparation process is suitable for large-scale industrial production.

(2) With regard to the composite structure of the multi-layer lithium metal battery anode of the present application, the fast ionic conductor layer has lithiophilicity. The fast ionic conductor not only has high ion conductivity, but also has excellent barrier properties, which is uniform and dense, protecting the metal lithium from erosion to stably exist in the air for a certain period of time. In the battery system, the fast ionic conductor layer can not only reduce the side reaction with the electrolyte, but also effectively reduce the lithium ion nucleation overpotential and facilitate uniform dispersion of lithium ions, reducing the nucleation drive for dendrites to suppress the growth of lithium dendrites. The thickness of the fast ionic conductor layer has a significant impact on the deposition rate of lithium ions. The fast ionic conductor layer with a thickness of 1.5-4.5 μm can not only maintain the effective transport of lithium ions, but also guarantee the uniformity of lithium ion deposition. The overly thick fast ionic conductor layer will reduce the transport efficiency of lithium ions, while the overly thin fast ionic conductor layer will affect the nucleation process of lithium, thereby reducing the uniformity of lithium deposition. The protection material in the functional protection layer can react with lithium dendrites to generate inert substances. Once the lithium dendrites grow to a certain extent where the lithium dendrites can touch the functional protection layer, the protection material can react with lithium to form inert substances, thereby inhibiting the uneven growth of lithium dendrites, avoiding the risk of short circuits inside the battery, and improving the safety performance, and simultaneously improving the cycle performance and service life of the battery during the charging and discharging process; however, if the dense and uniform protection material is solely introduced onto the fast ionic conductor layer, due to the poor ion conductivity of iodine or sulfur, the transport of lithium ions will be hindered to a certain extent, and thus the capacity will be reduced. Therefore, it is necessary to introduce a polymer solid electrolyte to “dilute” the protection material. Without affecting the reaction of protection material and lithium dendrites to generate inert substances, the polymer solid electrolyte improves the ion conductivity and has good organic flexibility, which can effectively relieve the stress caused by the volume change of lithium metal during electrochemical cycling. In addition, the functional protection layer is uniformly coated on the fast ionic conductor material, and part of the protection material penetrates into the fast ionic conductor layer, which can inhibit the formation of lithium dendrites and enhance the conductivity of lithium ions.

### BRIEF DESCRIPTION OF DRAWINGS

FIG. 1 is a schematic structural diagram of a multi-layer lithium metal battery anode of the present application.

FIG. 2 is a schematic structural diagram of a device for preparing the multi-layer lithium metal battery anode of the present application.

FIG. 3 shows cycle performance comparison between batteries of Example 1 and Comparative Example 1.

### REFERENCE LIST

1. Current collector
2. Lithium metal layer
3. Fast ionic conductor layer
4. Functional protection layer
5. Unwinding roller
6. Guide roller
6′. Guide roller
7. Temperature control unit
7′. Temperature control unit
8. Evaporation tank
8′. Evaporation tank
9. Airflow baffle
9′. Airflow baffle
10. Temperature control roller
10′. Temperature control roller
11. Film thickness measuring apparatus
11′. Film thickness measuring apparatus
12. Heat preservation roller
13. Cooling roller
14. Winding roller
15. First vacuum evaporation apparatus
16. Second vacuum evaporation apparatus
17. Vacuum chamber

### DETAILED DESCRIPTION

As described above, the present application provides a multi-layer lithium metal battery anode, which includes a current collector, a lithium metal layer, a fast ionic conductor layer and a functional protection layer.

In a preferred embodiment of the present application, the lithium metal layer is arranged on one side of the current collector, the fast ionic conductor layer is arranged on one side of the lithium metal layer facing away from the current collector, and the functional protection layer is arranged on one side of the fast ionic conductor layer facing away from the current collector.

In a preferred embodiment of the present application, the fast ionic conductor layer includes halide salt or oxide or peroxide or nitride which contains one or more metals selected from lithium, magnesium or copper; the halide salt is preferably chloride, iodide and/or fluoride; preferably, the fast ionic conductor layer includes one or a combination of at least two of lithium chloride, lithium sulfide, lithium iodide, lithium fluoride, magnesium fluoride, copper oxide, lithium oxide, magnesium nitride, lithium phosphide, lithium bromide or lithium peroxide; more preferably, the fast ionic conductor layer includes one or a combination of at least two of lithium chloride, lithium sulfide, lithium iodide, lithium fluoride, magnesium fluoride or copper oxide; particularly preferably, the fast ionic conductor layer includes one or a combination of at least two of lithium chloride, lithium sulfide, lithium iodide or lithium fluoride.

In a preferred embodiment of the present application, the functional protection layer includes a protection material and a polymer solid electrolyte.

In a preferred embodiment of the present application, the protection material includes iodine and/or sulfur.

In a preferred embodiment of the present application, the polymer solid electrolyte includes one or a combination of at least two of polyvinylidene fluoride (PVDF), polyethylene oxide (PEO), polypropylene oxide (PPO), polyvinylidene chloride (PVDC), polyvinyl chloride (PVC), polyacrylonitrile (PAN), polymethyl methacrylate (PMMA), polyacrylate, poly(vinylidene fluoride-co-hexafluoro propylene) (PVDF-HFP), poly(propylene carbonate) (PPC) or poly(ethyl cyanoacrylate); preferably, the polymer solid electrolyte includes one or a combination of at least two of polyvinylidene fluoride (PVDF), polyethylene oxide (PEO), polypropylene oxide (PPO), polyvinylidene chloride (PVDC), polyvinyl chloride (PVC), polyacrylonitrile (PAN) or polymethyl methacrylate (PMMA).

In a preferred embodiment of the present application, a mass ratio of the protection material to the polymer solid electrolyte is 1:(0.9-1.5), preferably 1:(1.0-1.5).

In a preferred embodiment of the present application, the multi-layer lithium metal battery anode has a thickness of 14.0-45.0 μm, preferably 15.3-36.7 μm.

In a preferred embodiment of the present application, the current collector has a thickness of 10.0-18 μm, preferably 10.0-15 μm.

In a preferred embodiment of the present application, the lithium metal layer has a thickness of 1.0-18.0 μm, preferably 1.5-15.0 μm, more preferably 1.7-14.4 μm.

In a preferred embodiment of the present application, the fast ionic conductor layer has a thickness of 1.5-4.5 μm, preferably 2.3-3.8 μm.

In a preferred embodiment of the present application, the functional protection layer has a thickness of 1.5-4.5 μm, preferably 1.5-2.9 μm.

The present application also provides a preparation method for the multi-layer lithium metal battery anode, which includes the following steps:
(1) a step of depositing lithium metal via evaporation;
(2) a step of depositing a fast ionic conductor via evaporation; and
(3) a step of coating a protection material and a polymer solid electrolyte.

In a preferred embodiment of the present application, step (1) and step (2) are performed in a continuous and integrated manner.

In a preferred embodiment of the present application, step (1) includes: heating a lithium source under vacuum in an inert atmosphere, and allowing lithium metal vapor to deposit on a current collector, thereby forming a current collector having a lithium metal layer.

In a preferred embodiment of the present application, step (2) includes: heating the fast ionic conductor under vacuum in an inert atmosphere, and allowing fast ionic conductor vapor to deposit on the current collector having a lithium metal layer, thereby forming a current collector having a lithium metal layer and deposited with a fast ionic conductor layer.

In a preferred embodiment of the present application, step (3) includes: adding the protection material into an organic solution, and performing ultrasonic dispersion and magnetic stirring in sequence to obtain a uniform slurry; coating the slurry on the current collector having a lithium metal layer and deposited with a fast ionic conductor layer obtained in step (2), and then performing drying, preferably, transferring into an oven and performing drying, to obtain the multi-layer lithium metal battery anode.

In a preferred embodiment of the present application, in step (1) and step (2), the inert atmosphere is an argon atmosphere.

In a preferred embodiment of the present application, in step (3), the organic solution is a mixed solution of the polymer solid electrolyte with dimethylformamide (DMF) or N-methylpyrrolidone (NMP), and a mass ratio of the polymer solid electrolyte to DMF or NMP is 1:(8-10).

It should be noted that an amount of DMF or NMP in the mixed solution is not particularly limited, as long as the polymer solid electrolyte and the protection material can be dissolved or dispersed.

In a preferred embodiment of the present application, in step (3), the ultrasonic dispersion has a time of 1-3 h.

In a preferred embodiment of the present application, in step (3), the magnetic stirring has a time of 15-20 h.

In a preferred embodiment of the present application, in step (3), the magnetic stirring has a rotating speed of 800-1000 rpm.

In a preferred embodiment of the present application, in step (3), the drying has a temperature of 60-90° C.

In a preferred embodiment of the present application, in step (3), the drying has a time of 10-30 min.

In a preferred embodiment of the present application, in step (1), an initial temperature of the lithium source is 25° C., and a heating temperature of the lithium source is 550-750° C., preferably 600-750° C.

In a preferred embodiment of the present application, in step (1), a heating rate of the lithium source is 2-10° C./min, preferably 5-8° C./min.

In a preferred embodiment of the present application, in step (1), a temperature of the current collector is 80-100° C., preferably 80-90° C.

In a preferred embodiment of the present application, in step (1), a moving speed of the current collector is 1-8 m/min, preferably 2-6 m/min.

The current collector used in the present application is a common commercial battery grade copper foil.

In a preferred embodiment of the present application, in step (2), an initial temperature of the fast ionic conductor is 25° C., and a heating temperature of the fast ionic conductor is 700-1000° C., preferably 800-1000° C.

In a preferred embodiment of the present application, in step (2), a heating rate of the fast ionic conductor is 2-10° C./min, preferably 5-8° C./min.

In a preferred embodiment of the present application, in step (2), a temperature of the current collector having a lithium metal layer is 80-100° C., preferably 80-90° C.

In a preferred embodiment of the present application, in step (2), a moving speed of the current collector having a lithium metal layer is 1-8 m/min, preferably 2-6 m/min.

In the present application, the moving speeds of the current collector, the current collector having a lithium metal layer, and the current collector having a lithium metal layer and deposited with a fast ionic conductor layer are equal to a conveying speed of the conveying apparatus, for example, equal to a winding speed of the winding collection apparatus.

In a specific embodiment of the present application, since the current collector, the current collector having a lithium metal layer, and the current collector having a lithium metal layer and deposited with a fast ionic conductor layer are connected in series by the conveying apparatus, the current collector, the current collector having a lithium metal layer, and the current collector having a lithium metal layer and deposited with a fast ionic conductor layer have the same moving speed which is equal to the conveying speed of the conveying apparatus, for example, equal to the winding speed of the winding collection apparatus.

In a preferred embodiment of the present application, in step (1) and step (2), a vacuum degree is 1×10⁻⁴ to 1×10⁻² Pa.

In a preferred embodiment of the present application, in step (1), the lithium source is a metal lithium ingot or a metal lithium melt, and a lithium purity of the lithium source is not particularly limited, as long as a predetermined evaporation effect can be obtained; generally, the lithium purity of the lithium source is greater than 95%, preferably greater than 98%.

It should be noted that the purity of metal lithium ingot or metal lithium melt cannot reach 100%, and it is inevitable to contain metal impurities or metal compound impurities. Due to the different vapor pressures of different metals at the same temperature, the condensation time points are also different during the evaporation. Therefore, in the vacuum evaporation step, based on the relationship between the metal vapor pressure and the temperature, the winding collection apparatus is started in advance, and sodium and potassium impurities in the lithium ingot are first transformed into gaseous state and deposited on the current collector by adjusting the temperature. In the subsequent process, this section of product can be cut off for centralized recycling.

In a preferred embodiment of the present application, in step (2), the fast ionic conductor is one or a combination of at least two of lithium chloride, lithium sulfide, lithium iodide, lithium fluoride, magnesium fluoride, copper oxide, lithium oxide, magnesium nitride, lithium phosphide, lithium bromide or lithium peroxide, preferably one or a combination of at least two of lithium chloride, lithium sulfide, lithium iodide, lithium fluoride, magnesium fluoride or copper oxide.

In a preferred embodiment of the present application, in step (2), a purity of the fast ionic conductor is not particularly limited, as long as a predetermined evaporation effect can be obtained; generally, the purity of the fast ionic conductor is greater than 99.0%, preferably greater than 99.9%.

In a preferred embodiment of the present application, in step (3), a purity of the protection material is not particularly limited, as long as a predetermined effect can be obtained; the purity of the protection material is greater than 99.0%, preferably greater than 99.9%; a purity of the polymer solid state electrolyte is not particularly limited, as long as a predetermined effect can be obtained; generally, the purity of the polymer solid state electrolyte is greater than 99.0%, preferably greater than 99.9%.

The present application also provides a device for preparing the multi-layer lithium metal battery anode, which is used to implement the preparation method of the multi-layer lithium metal battery anode, including a first vacuum evaporation apparatus, a second vacuum evaporation apparatus and a conveying apparatus which are arranged in a same vacuum chamber;

wherein the first vacuum evaporation apparatus and the second vacuum evaporation apparatus independently include an evaporation tank and a temperature control unit, preferably, the first vacuum evaporation apparatus and the second vacuum evaporation apparatus independently include one evaporation tank and one temperature control unit;

the two vacuum evaporation apparatuses are equipped with a film thickness measuring apparatus;

the conveying apparatus includes a winding collection apparatus, and preferably, the winding collection apparatus includes an unwinding roller, a guide roller, a temperature control roller, a heat preservation roller, a cooling roller and a winding roller. More preferably, the winding collection apparatus includes one unwinding roller, a plurality of (preferably three to five) guide rollers, a plurality of (preferably three to five) temperature control rollers, one heat preservation roller, one cooling roller and one winding roller.

In a preferred embodiment of the present application, the temperature control unit is used to heat the evaporation tank. The temperature control unit is equipped with a resistance heating source and a heat preservation layer, which has heating and heat preservation functions, and can continuously and stably provide the sample to be evaporated with heat source and heat preservation.

In a preferred embodiment of the present application, two vacuum evaporation apparatuses are arranged in a same vacuum chamber and connected in series by a conveying apparatus such as a winding collection apparatus for the continuous and integrated connection of the substrate to be deposited on.

In a preferred embodiment of the present application, the evaporation tank is a crucible, preferably one or a combination of at least two of a platinum crucible, a nickel crucible or an iron crucible.

In the present application, the first vacuum evaporation apparatus is used for evaporating and depositing lithium metal onto the current collector to form a current collector having a lithium metal layer; the second vacuum evaporation apparatus is used for evaporating and depositing the fast ionic conductor onto the current collector having a lithium metal layer to form a current collector having a lithium metal layer and deposited with a fast ionic conductor layer.

In a preferred embodiment of the present application, a film thickness measuring apparatus is independently arranged on an outlet side of each vacuum evaporation apparatus for measuring the thickness of the foil after evaporation. The film thickness measuring apparatus can perform real-time monitoring during the evaporation process, and can control the temperature of the temperature control unit based on the measured film thickness value. By increasing the temperature to accelerate the thermal motion of the vapor molecules, the vapor output from the crucible can be increased to a certain extent, and the evaporation amount can be increased at the same time, and the film thickness can be increased accordingly. Similarly, by reducing the temperature to slow down the thermal motion of the vapor molecules, the effect of reducing the vapor output, evaporation amount and film thickness can be achieved.

In a preferred embodiment of the present application, a airflow baffle and a guide plate are arranged in each vacuum evaporation apparatus independently, preventing vapor from overflowing the evaporation apparatus.

In the present application, the evaporation tank of the first vacuum evaporation apparatus is used for containing the lithium source; the evaporation tank of the second vacuum evaporation apparatus is used for containing the fast ionic conductor.

In the present application, the conveying apparatus can transport the current collector to the first vacuum evaporation apparatus, and transport the current collector having a lithium metal layer to the second vacuum evaporation apparatus.

The device of the present application will be further described below with reference to the accompanying drawing.

In the present application, a first vacuum evaporation apparatus 15 includes a temperature control unit 7, an evaporation tank 8, a airflow baffle 9 and a guide plate, and a second vacuum evaporation apparatus 16 includes a temperature control unit 7′, an evaporation tank 8′, a airflow baffle 9′ and a guide plate.

In the present application, by adjusting a temperature of the temperature control unit 7 in the first vacuum evaporation apparatus, a heating temperature of the evaporation tank 8 containing a lithium source can be controlled to 550-750° C., preferably 600-750° C. In the present application, an initial temperature of the evaporation tank 8 is 25° C.

In the present application, by adjusting the temperature control unit 7 in the first vacuum evaporation apparatus, a heating rate of the evaporation tank 8 containing a lithium source can be controlled to 2-10° C./min, preferably 5-8° C./min.

In the present application, by adjusting a height of the temperature control roller 10 above the first vacuum evaporation apparatus, a distance between the evaporation tank 8 containing a lithium source and the current collector can be adjusted to 10-40 mm, preferably 15-30 mm.

In the present application, by adjusting a temperature of the temperature control roller 10 above the first vacuum evaporation apparatus, a temperature of the current collector can be controlled to 80-100° C., preferably 80-90° C.

In the present application, by adjusting a temperature of the heat preservation roller 12, a temperature of the current collector having a lithium metal layer can be maintained at 70-80° C.

In the present application, by adjusting the winding collection apparatus, a moving speed of the current collector can be controlled to 1-8 m/min, preferably 2-6 m/min.

In the present application, by adjusting a temperature of the temperature control unit 7′ of the second vacuum evaporation apparatus, a heating temperature of the evaporation tank 8′ containing a fast ionic conductor can be controlled to 700-1000° C., preferably 800-1000° C. In the present application, an initial temperature of the evaporation tank 8′ is 25° C.

In the present application, by adjusting the temperature control unit 7′ in the second vacuum apparatus, a heating rate of the evaporation tank 8′ containing a fast ionic conductor can be controlled to 2-10° C./min, preferably 5-8° C./min.

In the present application, by adjusting a height of the temperature control roller 10′ above the second vacuum evaporation apparatus, a distance between the evaporation tank 8′ containing a fast ionic conductor and the current collector having a lithium metal layer can be controlled to 40-80 mm, preferably 50-70 mm.

In the present application, by adjusting a temperature of the temperature control roller 10′ above the second vacuum evaporation apparatus, a temperature of the current collector having a lithium metal layer can be controlled to 80-100° C., preferably 80-90° C.

In the present application, by adjusting a temperature of the cooling roller 13, the current collector having a lithium metal layer and deposited with a fast ionic conductor layer can be controlled to 40-50° C.

In the present application, by adjusting the winding collection apparatus, a moving speed of the current collector having a lithium metal layer can be controlled to 1-8 m/min, preferably 2-6 m/min.

In the present application, the first vacuum evaporation apparatus and the second vacuum evaporation apparatus are arranged in a same vacuum chamber.

In the present application, a vacuum degree of the vacuum chamber is 1×10⁻⁴-1×10⁻² Pa, and a water oxygen value is less than 0.1 ppm. In the present application, an inert atmosphere is introduced into the vacuum chamber, and the inert atmosphere is an argon atmosphere.

Each vacuum evaporation apparatus is equipped with its respective temperature control unit for independently controlling the heating temperature of the evaporation tank, wherein each temperature control unit includes a heating apparatus and a heat preservation layer. The evaporation tank is a crucible, preferably one or more of a platinum crucible, a nickel crucible or an iron crucible.

To facilitate the understanding of the content in the present application, the technical solutions of the present application will be further described below with reference to specific embodiments, but the present application is not limited thereto.

The manufacturer of the raw materials and equipment used in the examples and the equipment and analytical methods used in product analysis are described below, and the reagents, instruments or operation steps not recorded in this disclosure can be routinely determined by those skilled in the art.

A coating machine is purchased from Shenzhen Kejingzhida Technology Co., Ltd., and the model is MSK-AFA-MC400.

An ultrasonic disperser is purchased from Shanghai Ningshang Ultrasonic Instrument Co., Ltd., and the model is SY-250.

A magnetic stirrer is purchased from THINKY Japan Co., Ltd., and the model is ARM-310.

An electronic analytical balance is purchased from Sartorius Scientific Instruments (Beijing) Co., Ltd., and the model is CUBIS_II_SEMI-MICRO.

The platinum crucible, nickel crucible, iron crucible and ceramic crucible are purchased from Tianjin Yinpeng Development Metal Products Co., Ltd.

Battery testing equipment is purchased from Shenzhen Newwell Electronics Co., Ltd., and the model is CT-4008T-5V6A.

An atomic absorption spectrometer is purchased from Shanghai Spectrum Instruments Co., Ltd., and the model is SP-3803AA.

The lithium source is purchased from Jiangxi Ganfeng Lithium Co., Ltd.

The fast ionic conductor material, protection material and polymer solid electrolyte material are purchased from Shanghai Maclean Biochemical Technology Co., Ltd.

### EXAMPLES

### Example 1

### (0) Feeding and Vacuuming

A vacuum chamber (including a first vacuum evaporation apparatus and a second vacuum evaporation apparatus) was set to an argon atmosphere, and a metal lithium ingot with a mass of 300 g (a purity of the metal lithium ingot was 99.0%) was added to a crucible in the first vacuum evaporation apparatus, and lithium chloride with a mass of 100 g was added to a crucible in the second vacuum evaporation apparatus. Then, a vacuum degree of the vacuum chamber was set to 1×10⁻³ Pa, and a water oxygen value was kept at less than 0.1 ppm.

### (1) Depositing Lithium Metal Via Evaporation

The crucible containing 300 g of metal lithium ingot in the first vacuum evaporation apparatus was heated to 650° C. with a constant heating rate of 5° C./min and maintained at the temperature, and the metal lithium ingot was changed from solid state into liquid state and finally into lithium vapor. A temperature of a temperature control roller was adjusted to adjust a temperature of the current collector to 90° C., and lithium vapor was deposited on the current collector with a temperature of 90° C. and a thickness of 10 μm, thereby forming a dense and uniform current collector having a lithium metal layer, wherein a distance between the crucible and the current collector was 25 mm, and a winding speed of the winding collection apparatus (i.e. a moving speed of the current collector) was set to 4.5 m/min.

A thickness of the lithium metal layer was measured to be 9.2 μm by using a film thickness measuring apparatus, and a lithium purity of the lithium metal layer was measured to be 99.995% by using an atomic absorption spectrometer.

### (2) Depositing a Fast Ionic Conductor Via Evaporation

The current collector having a lithium metal layer was transported to the second vacuum evaporation apparatus by a heat preservation roller of the winding collection apparatus, wherein a winding speed of the winding collection apparatus (i.e. a moving speed of the current collector having a lithium metal layer) was 4.5 m/min, and the heat preservation roller maintained a temperature of the current collector having a lithium metal layer at 80° C.

The crucible containing 100 g of lithium chloride in the second vacuum evaporation apparatus was heated to 850° C. with a constant heating rate of 6° C./min and maintained at the temperature. A temperature of the temperature control roller was adjusted to adjust a temperature of the current collector having a lithium metal layer to 90° C., and lithium chloride vapor was deposited onto the current collector having a lithium metal layer at 90° C. to form a current collector having a lithium metal layer and deposited with a fast ionic conductor layer, wherein a distance between the crucible and the current collector having a lithium metal layer was 60 mm, and a winding speed of the winding collection apparatus was 4.5 m/min consistent with step (1).

A thickness of the fast ionic conductor layer was measured to be 2.94 μm by using a film thickness measuring apparatus. The thickness of the fast ionic conductor layer was obtained by subtracting the thickness of the current collector having a lithium metal layer prepared in step (1) from a thickness of the current collector having a lithium metal layer and deposited with a fast ionic conductor layer.

### (3) Coating a Protection Material and a Polymer Solid Electrolyte

A protection material, 100 g of iodine, was added to an organic solution, wherein the organic solution was a mixed solution of 100 g of PVDF and 800 g of N-methylpyrrolidone (NMP), and subjected to ultrasonic dispersion for 1 h and then magnetic stirring for 18 h with a rotating speed of 900 rpm to obtain a uniform slurry; the slurry was coated on the current collector having a lithium metal layer and deposited with a fast ionic conductor layer obtained in step (2) by using a coating machine, then transferred into an oven at a temperature of 80° C. and dried for 15 min to obtain a functional protection layer, wherein a mass ratio of a protection material in the functional protection layer to the polymer solid electrolyte was 1.0:1.0, and finally a multi-layer lithium metal battery anode was obtained.

A thickness of the functional protection layer was measured to be 2.88 μm by using a film thickness measuring apparatus, and the thickness of the functional protection layer was obtained by subtracting the thickness of the current collector having a lithium metal layer and deposited with a fast ionic conductor layer from a thickness of the multi-layer lithium metal battery anode.

### Examples 2-6

The steps and contents of the preparation methods of Examples 2-6 are basically the same as those of Example 1, and the difference lies in components and process parameters, which are specifically shown in Tables 1-3.

### Comparative Example 1

The steps and contents of the preparation method of Comparative Example 1 are basically the same as those of Example 1, and the difference lies in that only step (0) and step (1) of lithium metal evaporation and deposition treatment were performed in Comparative Example 1, while step (2) of depositing a fast ionic conductor via evaporation and step (3) of coating a protection material and a polymer solid electrolyte were not performed.

### Comparative Example 2

The steps and contents of the preparation method of Comparative Example 2 are basically the same as those of Example 1, and the difference lies in that only step (0), step (1) of depositing lithium metal via evaporation, and step (2) of depositing a fast ionic conductor via evaporation were performed in Comparative Example 2, while step (3) of coating a protection material and a polymer solid electrolyte were not performed.

### Comparative Example 3

The steps and contents of the preparation method of Comparative Example 3 are basically the same as those of Example 1, and the difference lies in that only step (0), step (1) of depositing lithium metal via evaporation, and step (3) of coating a protection material and a polymer solid electrolyte were performed in Comparative Example 3, while step (2) of depositing a fast ionic conductor via evaporation were not performed.

### Comparative Example 4

The steps and contents of the preparation method of Comparative Example 4 are basically the same as those of Example 1, and the difference lies in that although step (0), step (1) of depositing lithium metal via evaporation, step (2) of depositing a fast ionic conductor via evaporation and step (3) of coating were performed in Comparative Example 4, a functional protection layer prepared in step (3) was obtained by only coating a protection material and contained no polymer solid electrolyte (i.e. polyvinylidene fluoride).

### Comparative Example 5

The steps and contents of the preparation method of Comparative Example 5 are basically the same as those of Example 1, and the difference lies in that although step (0), step (1) of depositing lithium metal via evaporation, step (2) of depositing a fast ionic conductor via evaporation and step (3) of coating were performed in Comparative Example 5, a functional protection layer prepared in step (3) was obtained by only coating a polymer solid electrolyte and contained no protection material (i.e. iodine).

Tables 1-3 show the components and process parameters of Examples 1-6 and Comparative Examples 1-5, wherein Table 1 shows the process parameters of step (0) and step (1) in Examples 1-6 and Comparative Examples 1-5, Table 2 shows the components and process parameters of step (2) in Examples 1-6 and Comparative Examples 1-5, and Table 3 shows the components and process parameters of step (3) in Examples 1-6 and Comparative Examples 1-5.

TABLE 1

| | | | | Distance | | | | |
|---|---|---|---|---|---|---|---|---|
| | | | | between | | | | |
| | | | | crucible | | | Thickness | Purity of |
| | | Heating | | and | Temperature | | of lithium | lithium |
| | Vacuum | temperature | Heating | current | of current | Winding | metal | metal |
| | degree | of crucible | rate | collector | collector | speed | layer | layer |
| No. | (Pa) | (° C.) | (° C./min) | (mm) | (° C.) | (m/min) | (μm) | (%) |
| Example 1 | 1 × 10⁻³ | 650 | 5.0 | 25 | 90 | 4.5 | 9.2 | 99.995 |
| Example 2 | 1 × 10⁻² | 550 | 8.0 | 40 | 100 | 8.0 | 1.7 | 99.995 |
| Example 3 | 1 × 10⁻³ | 700 | 6.0 | 25 | 90 | 3.0 | 14.4 | 99.999 |
| Example 4 | 1 × 10⁻⁴ | 750 | 7.0 | 10 | 82 | 2.0 | 17.9 | 99.992 |
| Example 5 | 3 × 10⁻³ | 680 | 10.0 | 30 | 80 | 3.0 | 10.1 | 99.994 |
| Example 6 | 8 × 10⁻³ | 600 | 2.0 | 32 | 88 | 6.0 | 5.7 | 99.996 |
| Comparative | 1 × 10⁻³ | 650 | 5.0 | 25 | 90 | 4.5 | 9.2 | 99.995 |
| Example 1 | | | | | | | | |
| Comparative | 1 × 10⁻³ | 650 | 5.0 | 25 | 90 | 4.5 | 9.2 | 99.995 |
| Example 2 | | | | | | | | |
| Comparative | 1 × 10⁻³ | 650 | 5.0 | 25 | 90 | 4.5 | 9.1 | 99.994 |
| Example 3 | | | | | | | | |
| Comparative | 1 × 10⁻³ | 650 | 5.0 | 25 | 90 | 4.5 | 9.1 | 99.993 |
| Example 4 | | | | | | | | |
| Comparative | 1 × 10⁻³ | 650 | 5.0 | 25 | 90 | 4.5 | 9.3 | 99.997 |
| Example 5 | | | | | | | | |

TABLE 2

| | | | | | Distance | | |
|---|---|---|---|---|---|---|---|
| | | | | | between | | |
| | | | | | crucible | | |
| | | | | | and | Temperature | |
| | | | | | current | of current | |
| | | | | | collector | collector | |
| | | Heating | | | having a | having a | Thickness of |
| | Amount of | temperature | Heating | Winding | lithium | lithium | fast ionic |
| | fast ionic | of crucible | rate | speed | metal layer | metal layer | conductor |
| No. | conductor | (° C.) | (° C./min) | (m/min) | (mm) | (° C.) | (μm) |
| Example 1 | 100 g of | 850 | 6 | 4.5 | 60 | 90 | 2.94 |
| | lithium | | | | | | |
| | chloride | | | | | | |
| Example 2 | 100 g of | 700 | 8 | 8.0 | 80 | 100 | 1.53 |
| | lithium | | | | | | |
| | iodide | | | | | | |
| Example 3 | 100 g of | 900 | 2 | 3.0 | 55 | 90 | 3.81 |
| | lithium | | | | | | |
| | fluoride | | | | | | |
| Example 4 | 100 g of | 1000 | 5 | 2.0 | 40 | 80 | 4.44 |
| | lithium | | | | | | |
| | fluoride | | | | | | |
| Example 5 | 100 g of | 800 | 10 | 3.0 | 70 | 90 | 3.66 |
| | lithium | | | | | | |
| | sulfide | | | | | | |
| Example 6 | 100 g of | 850 | 7 | 6.0 | 50 | 85 | 2.34 |
| | lithium | | | | | | |
| | chloride | | | | | | |
| Comparative | — | — | — | 4.5 | — | — | — |
| Example 1 | | | | | | | |
| Comparative | 100 g of | 850 | 6 | 4.5 | 60 | 90 | 2.91 |
| Example 2 | lithium | | | | | | |
| | chloride | | | | | | |
| Comparative | — | — | — | 4.5 | — | — | — |
| Example 3 | | | | | | | |
| Comparative | 100 g of | 850 | 6 | 4.5 | 60 | 90 | 2.97 |
| Example 4 | lithium | | | | | | |
| | chloride | | | | | | |
| Comparative | 100 g of | 850 | 6 | 4.5 | 60 | 90 | 02.96 |
| Example 5 | lithium | | | | | | |
| | chloride | | | | | | |

TABLE 3

| | | Polymer solid | Thickness of | Mass ratio of protection |
|---|---|---|---|---|
| | Protection material | electrolyte and its | functional protection | material to polymer solid |
| No. | and its amount (g) | amount (g) | layer (μm) | electrolyte |
| Example 1 | 100 g of iodide | 100 g of PVDF | 2.88 | 1.0:1.0 |
| Example 2 | 100 g of iodide | 150 g of PEO | 1.50 | 1.0:1.5 |
| Example 3 | 100 g of sulfur | 90 g of PPO | 1.71 | 1.0:0.9 |
| Example 4 | 50 g of iodide and | 100 g of PPO | 4.50 | 1.0:1.0 |
| | 50 g of sulfur | | | |
| Example 5 | 100 g of sulfur | 150 g of PEO | 2.10 | 1.0:1.5 |
| Example 6 | 100 g of iodide | 120 g of PMMA | 2.55 | 1.0:1.2 |
| Comparative | — | — | — | — |
| Example 1 | | | | |
| Comparative | — | — | — | — |
| Example 2 | | | | |
| Comparative | 100 g of iodide | 100 g of PVDF | 2.85 | 1.0:1.0 |
| Example 3 | | | | |
| Comparative | 100 g of iodide | 0 g of PVDF | 1.73 | — |
| Example 4 | | | | |
| Comparative | 0 g of iodide | 100 g of PVDF | 1.86 | — |
| Example 5 | | | | |

### Performance Tests

The anodes prepared in Examples 1-6 and Comparative Examples 1-5 are prepared into pouch cells (lithium metal batteries) according to the following steps, and the pouch cells are tested.

### (1) Preparation of Positive Electrode Sheet

In parts by mass, 86 parts of lithium iron phosphate as a positive active material, 9 parts of polyvinylidene fluoride PVDF as a binder, 5 parts of conductive carbon black Super P as a conductive agent, and 130 parts of N-methylpyrrolidone were added in a homogenizer, stirred and mixed at 27° C. for 1 min at a stirring speed of 800 rpm, and then mixed for 15 min at a stirring speed of 1200 rpm to obtain a positive electrode slurry, and the positive electrode slurry was uniformly coated on a positive current collector aluminum foil of 20 μm thickness, and then dried at 100° C., cold-pressed, trimmed, cut, sliced, and then dried under a vacuum condition of 85° C. and 300 Pa for 4 h, and tabs were soldered to obtain a positive electrode sheet.

### (2) Preparation of Anode Sheet

The multi-layer lithium metal battery anodes prepared in Examples 1-6 and Comparative Examples 1-5 were cold-pressed, trimmed, cut and sliced to obtain anode sheets.

### (3) Separator

A polyethylene film (PE) was used as the separator with a thickness of 10 μm.

### (4) Assembly of Pouch Cell

The obtained positive electrode sheet, anode sheet and separator were assembled into a core in a laminated manner, the core was packaged and soldered, an aluminum plastic film was used for packaging, an electrolyte (an electrolyte formula was ethylene carbonate (EC):ethyl methyl carbonate (EMC):diethyl carbonate (DEC)=2:5:3, including 1.0 mol/L of lithium hexafluorophosphate) was injected, and a pouch cell (a thickness of 3.8 mm, a width of 34 mm, and a length of 50 mm) was obtained.

The following performance tests were performed on the pouch cells prepared from the multi-layer lithium metal battery anodes prepared in Examples 1-6 and Comparative Examples 1-5.

### (1) Room-Temperature Cycle Performance Test

The battery was assembled at 25° C. and then allowed to stand for 10 h first.

The battery was charged to 4.2 V at 0.1C by constant-current charging, then charged to a cut-off current at 0.02C by constant-voltage charging, allowed to stand for 10 min, then discharged to 2.5 V at 0.1C by constant-current discharging, and allowed to stand for 10 min, the above operations were repeated twice, and then the battery was activated.

The activated battery was charged to 4.2 V at 1C by constant-current charging, then charged to a cut-off current at 0.02C by constant-voltage charging, allowed to stand for 10 min, then discharged to 2.5 V at 0.1C by constant-current discharging, and allowed to stand for 10 min, and then tested for the first cycle discharge capacity. Then, the battery was subjected to charge-discharge cycle test at 1C. The battery was tested for the specific capacity and capacity retention rate at the 500th charge-discharge cycle, and tested for the cycle life. The capacity retention rate of the lithium-ion battery after the 500th cycle was calculated according to the following formula:

Capacity retention rate after the 500th cycle=(Discharge capacity after the 500th cycle/first cycle discharge capacity)×100%.

The standard cycle life of a battery refers to the charge-discharge cycle count which is bearable for the battery before the battery capacity decays to 80% of its initial capacity under a certain charge-discharge system. One cycle includes both a full charge and a full discharge.

### (2) Safety Performance Test

In accordance with GB/T 31485-2015 “Safety Requirements and Test Methods for Traction Battery for Electric Vehicle”, the battery after cycling 200 times at 25° C. was subjected to the puncture test. A steel needle is used to pierce the battery cell (or module) through and forcibly destroys the internal structure of the battery, causing internal short circuits and further thermal runaway. If the battery does not explode or catch fire within 1 hour after pierced through by the needle, the battery can be determined to pass the puncture test. The results are shown in Table 4.

TABLE 4

| | | Specific | Capacity | | |
|---|---|---|---|---|---|
| | First cycle | capacity | retention rate | | Whether |
| | specific | after the | after the | | passing |
| | capacity | 500th cycle | 500th cycle | Cycle | puncture |
| No. | (mAh/g) | (mAh/g) | (%) | life | test |
| Example 1 | 152.71 | 142.79 | 93.51 | 2100 | Yes |
| Example 2 | 153.22 | 141.05 | 92.06 | 2120 | Yes |
| Example 3 | 149.59 | 137.97 | 92.23 | 1970 | Yes |
| Example 4 | 149.16 | 139.36 | 93.43 | 2080 | Yes |
| Example 5 | 147.43 | 136.65 | 92.01 | 2020 | Yes |
| Example 6 | 149.08 | 137.97 | 92.55 | 1940 | Yes |
| Comparative | 148.75 | 57.48 | 38.64 | 157 | No |
| Example 1 | | | | | |
| Comparative | 146.23 | 124.31 | 85.01 | 604 | No |
| Example 2 | | | | | |
| Comparative | 137.10 | 36.78 | 26.83 | 138 | No |
| Example 3 | | | | | |
| Comparative | 144.74 | 124.98 | 86.35 | 645 | No |
| Example 4 | | | | | |
| Comparative | 149.94 | 122.38 | 81.62 | 537 | No |
| Example 5 | | | | | |

As shown in Table 4, it can be seen from the test results of Examples 1-6 and Comparative Example 1 that the multi-layer lithium metal battery anode of Examples 1-6 includes a lithium metal layer, a fast ionic conductor layer and a functional protection layer, and the capacity retention rate of the battery is still greater than 90% after 500 cycles. It is indicated that the capacity decay of the lithium metal battery is reduced, and the cycle stability is significantly improved. The reason may be that there is basically no dead lithium and dendrites generated during the battery cycling, and most of the lithium ions can be stably intercalated and deintercalated the during battery cycling. In addition, Examples 1-6 all pass the puncture test, which indicates that the lithium metal battery which employs the multi-layer lithium metal battery anode of the present application has good safety. The functional protection layer of the present application can react with lithium dendrites to generate inert substances, which facilitates suppressing short circuits, fires, and the like.

In Comparative Example 1, the lithium metal battery anode does not include a fast ionic conductor layer and a functional protection layer. Although the initial specific capacity of Comparative Example 1 is close to that of Examples 1-6, subsequently, the capacity retention rate decreases significantly and the specific capacity decays rapidly. The reason is that during the battery cycling, the lithium battery anode without any surface deposition treatment has uneven deposition of lithium ions and forms dendrites, and the lithium metal battery anode has many side reactions with the electrolyte, resulting in excessive consumption of lithium ions.

As shown in Table 4, it can be seen from the test results of Examples 1-6 and Comparative Example 2 that the lithium metal battery anode in Comparative Example 2 does not include a functional protection layer; after 500 cycles, the specific capacity is 124.31 mAh/g, and the capacity retention rate is 85.01%. Although the initial specific capacity of Comparative Example 2 is close to that of Examples 1-6, and the battery in Comparative Example 2 can be stably cycled for a certain period of time, the problem of short battery cycle life has not been solved yet. Because the functional protection layer is not coated, the further growth of lithium dendrites cannot be completely prevented, and thus the lithium ions are further consumed, the specific capacity decays, and a large amount of lithium is “wasted”. Therefore, the lithium metal battery has poor cycle performance and safety and shortened cycle life.

As shown in Table 4, it can be seen from the test results of Examples 1-6 and Comparative Example 3 that the lithium metal battery anode in Comparative Example 3 does not include a fast ionic conductor layer; in Comparative Example 3, after 500 cycles, the specific capacity is 36.78 mAh/g, and the capacity retention rate is 26.83%. Comparative Example 3 has a lower initial specific capacity than Examples 1-6, and this is because the lithium metal layer is directly in contact with the functional protection layer inside the lithium metal battery anode of Comparative Example 3, and the lithium reacts with the protection material to form inert substances, which irreversibly consumes part of the lithium before the battery is used, resulting in a decrease in the first cycle discharge capacity. Meanwhile, due to the lack of a fast ionic conductor layer, uneven deposition of lithium ions is more likely to occur, forming dendrites and dead lithium, and consuming lithium ions continuously; the specific capacity decays rapidly, and the cycle life is significantly reduced.

As shown in Table 4, it can be seen from the test results of Examples 1-6 and Comparative Example 4 that the functional protection layer of the lithium metal battery anode in Comparative Example 4 does not contain a polymer solid electrolyte; in Comparative Example 4, after 500 cycles, the specific capacity is 124.98 mAh/g, and the capacity retention rate is 86.35%. The fast ionic conductor layer in Comparative Example 4 facilitates the uniform deposition of lithium ions, and the protection material in the functional protection layer can react with the grown dendrites to generate inert substances to ensure that the battery does not suffer from internal short circuits. However, the functional protection layer only contains the protection material but no polymer solid electrolyte, the ion conductivity of the protection material is weak, which hinders the transport of lithium ions to a certain extent, and along with the process of electrochemistry cycling, the specific capacity decays, and the cycle life is significantly shortened.

As shown in Table 4, it can be seen from the test results of Examples 1-6 and Comparative Example 5 that the functional protection layer of the lithium metal battery anode in Comparative Example 5 does not contain a protection material; after 500 cycles, the specific capacity is 122.38 mAh/g, and the capacity retention rate is 81.62%. Although the initial specific capacity of Comparative Example 5 is close to that of Examples 1-6, the cycle life is shorter, and this is because the functional protection layer contains no protection material and cannot prevent the further growth of lithium dendrites. Once the lithium ions deposits unevenly and accumulates to form dendrites and dead lithium, the lithium ions will be consumed continuously, which will reduce the specific capacity, shorten the cycle life, and bring safety risks.

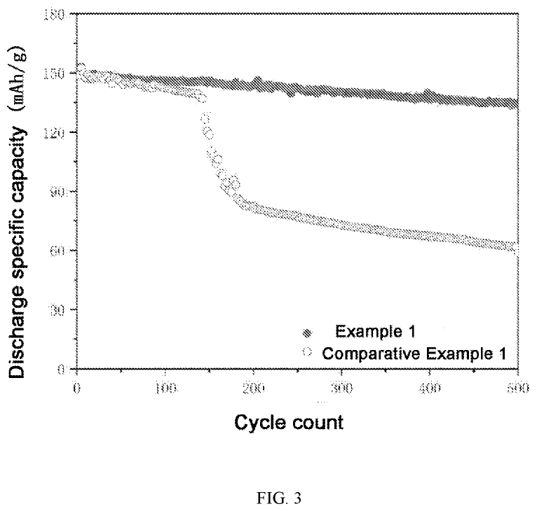

FIG. 3 shows cycle performance comparison between batteries of Example 1 and Comparative Example 1; it is obvious that the battery of Example 1 has a better cycle performance after activated at 0.1C than the battery in Comparative Example 1.

The surface-modified lithium metal anode of the present application obtains unexpectedly excellent composite effects, which has excellent performances in terms of cycle capacity retention rate and safety and stability. On the one hand, by using the continuous and integrated evaporation method in the present application, it is ensured that the functional materials of the lithium metal layer and the fast ionic conductor layer have extremely small particle size and extremely high density, and the functional materials of each layer have a super strong bond; therefore, the fast ionic conductor layer can completely cover the lithium metal layer and reduce the layer thickness to ultra-thin, avoiding increasing the internal resistance of the battery, and at the same time, the lithium ion transport rate is guaranteed, avoiding affecting the electrochemical performance of the battery. On the other hand, the present application has a unique composite structure; the fast ionic conductor layer has excellent barrier properties, protecting the metal lithium from erosion to stably exist in the air for a certain period of time, and thereby facilitating the subsequent coating process, and additionally, in the battery system, the fast ionic conductor layer can not only effectively reduce the side reaction with the electrolyte, but also effectively reduce the lithium ion nucleation overpotential and facilitate uniform dispersion of lithium ions, reducing the nucleation drive for dendrites to prevent the formation of lithium dendrites; the protection material in the functional protection layer can react with lithium dendrites to generate inert substances, which can inhibit the uneven growth of lithium dendrites to a certain extent and avoid the risk of internal short circuits; without affecting the reaction of protection material and lithium dendrites to generate inert substances, the polymer solid electrolyte in the functional protection layer has good organic flexibility, which can effectively relieve the stress caused by the volume change of lithium metal during electrochemical cycling.

In conclusion, with regard to the multi-layer lithium metal battery anode of the present application, by precisely depositing a lithium metal layer and a fast ionic conductor layer via evaporation and coating a functional protection layer, based on the composite synergistic effect of these three layers, the cycle performance, cycle life and safety of the lithium metal battery are significantly improved, and the problem of lithium dendrites in lithium metal anodes is solved.

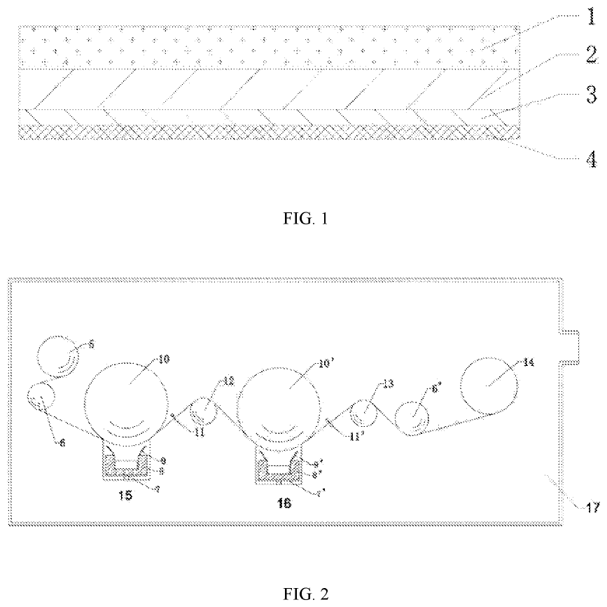

A schematic structural diagram of the multi-layer lithium metal battery anode of the present application is shown in FIG. 1, and a schematic diagram of the device of the present application is shown in FIG. 2. These schematic diagrams are used to illustrate the content conveniently rather than showing the actual size and proportion of the device of the present application.

Although the specific embodiments of the present application are described above, the protection scope of the present application is not limited thereto. The specific embodiments used to illustrate the present application are only used for a better understanding of the present application but not to limit the present application. Those skilled in the art to which the present application pertains can make some simple deductions, modifications or substitutions according to the concept of the present application. These deductions, modifications or substitutions also fall within the scope of the claims of the present application.

1. A multi-layer lithium metal battery anode, which comprises a current collector, a lithium metal layer, a fast ionic conductor layer and a functional protection layer.

2. The multi-layer lithium metal battery anode according to claim 1, wherein the lithium metal layer is arranged on one side of the current collector, the fast ionic conductor layer is arranged on one side of the lithium metal layer facing away from the current collector, and the functional protection layer is arranged on one side of the fast ionic conductor layer facing away from the current collector.

3. The multi-layer lithium metal battery anode according to claim 1, wherein the fast ionic conductor layer comprises halide salt or oxide or peroxide or nitride which contains one or more metals selected from lithium, magnesium or copper; the halide salt is preferably chloride, iodide and/or fluoride; preferably, the fast ionic conductor layer comprises one or a combination of at least two of lithium chloride, lithium sulfide, lithium iodide, lithium fluoride, magnesium fluoride, copper oxide, lithium oxide, magnesium nitride, lithium phosphide, lithium bromide or lithium peroxide; more preferably, the fast ionic conductor layer comprises one or a combination of at least two of lithium chloride, lithium sulfide, lithium iodide, lithium fluoride, magnesium fluoride or copper oxide; particularly preferably, the fast ionic conductor layer comprises one or a combination of at least two of lithium chloride, lithium sulfide, lithium iodide or lithium fluoride.

4. The multi-layer lithium metal battery anode according to claim 1, wherein the functional protection layer comprises a protection material which inhibits lithium activity and a polymer solid electrolyte.

5. The multi-layer lithium metal battery anode according to claim 4, wherein the protection material comprises iodine and/or sulfur;
or the polymer solid electrolyte comprises one or a combination of at least two of polyvinylidene fluoride (PVDF), polyethylene oxide (PEO), polypropylene oxide (PPO), polyvinylidene chloride (PVDC), polyvinyl chloride (PVC), polyacrylonitrile (PAN), polymethyl methacrylate (PMMA), polyacrylate, poly(vinylidene fluoride-co-hexafluoro propylene) (PVDF-HFP), poly(propylene carbonate) (PPC) or poly(ethyl cyanoacrylate); preferably, the polymer solid electrolyte comprises one or a combination of at least two of polyvinylidene fluoride (PVDF), polyethylene oxide (PEO), polypropylene oxide (PPO), polyvinylidene chloride (PVDC), polyvinyl chloride (PVC), polyacrylonitrile (PAN) or polymethyl methacrylate (PMMA).

6. The multi-layer lithium metal battery anode according to claim 4, wherein a mass ratio of the protection material to the polymer solid electrolyte is 1:(0.9-1.5), preferably 1:(1.0-1.5).

7. The multi-layer lithium metal battery anode according to claim 1, wherein the multi-layer lithium metal battery anode has a thickness of 14.0-45.0 μm, preferably 15.3-36.7 μm, wherein the current collector has a thickness of 10.0-18 μm, preferably 10.0-15 μm; the lithium metal layer has a thickness of 1.0-18.0 μm, preferably 1.5-15.0 μm, more preferably 1.7-14.4 μm; the fast ionic conductor layer has a thickness of 1.5-4.5 μm, preferably 2.3-3.8 μm; the functional protection layer has a thickness of 1.5-4.5 μm, preferably 1.5-2.9 μm.

8. A preparation method for the multi-layer lithium metal battery anode according to claim 1, comprising:
(1) a step of depositing lithium metal via evaporation;
(2) a step of depositing a fast ionic conductor via evaporation; and
(3) a step of coating a protection material and a polymer solid electrolyte.

9. The preparation method according to claim 8, wherein step (1) and step (2) are performed in a continuous and integrated manner.

10. The preparation method according to claim 8, wherein step (1) comprises: heating a lithium source under vacuum in an inert atmosphere, and allowing lithium metal vapor to deposit on a current collector, thereby forming a current collector having a lithium metal layer; or
step (2) comprises: heating the fast ionic conductor under vacuum in an inert atmosphere, and allowing fast ionic conductor vapor to deposit on the current collector having a lithium metal layer, thereby forming a current collector having a lithium metal layer and deposited with a fast ionic conductor layer; or
step (3) includes: adding the protection material into an organic solution, and performing ultrasonic dispersion and magnetic stirring in sequence to obtain a uniform slurry; coating the slurry on the current collector having a lithium metal layer and deposited with a fast ionic conductor layer obtained in step (2), and then performing drying to obtain the multi-layer lithium metal battery anode;
preferably, in step (1) and step (2), the inert atmosphere is an argon atmosphere; preferably, in step (3), the organic solution is a mixed solution of the polymer solid electrolyte with dimethylformamide or N-methylpyrrolidone, and a mass ratio of the polymer solid electrolyte to dimethylformamide or N-methylpyrrolidone is 1:(8-10);
preferably, in step (3), the ultrasonic dispersion has a time of 1-3 h, preferably, the magnetic stirring has a time of 15-20 h, preferably, the magnetic stirring has a rotating speed of 800-1000 rpm, preferably, the drying has a temperature of 60-90° C., preferably, the drying has a time of 10-30 min.

11. The preparation method according to claim 8, wherein in step (1), a heating temperature of the lithium source is 550-750° C., preferably 600-750° C.; or in step (2), a heating temperature of the fast ionic conductor is 700-1000° C., preferably 800-1000° C.

12. The preparation method according to claim 10, wherein in step (1) and step (2), a vacuum degree is 1×10⁻⁴ to 1×10⁻² Pa.

13. The preparation method according to claim 8, wherein,
in step (1), the lithium source is a metal lithium ingot or a metal lithium melt;
in step (2), the fast ionic conductor is one or a combination of at least two of lithium chloride, lithium sulfide, lithium iodide, lithium fluoride, magnesium fluoride, copper oxide, lithium oxide, magnesium nitride, lithium phosphide, lithium bromide or lithium peroxide, preferably one or a combination of at least two of lithium chloride, lithium sulfide, lithium iodide, lithium fluoride, magnesium fluoride or copper oxide.

14. A device used to implement the preparation method according to claim 8, comprising a first vacuum evaporation apparatus, a second vacuum evaporation apparatus and a conveying apparatus which are arranged in a same vacuum chamber;
wherein the first vacuum evaporation apparatus and the second vacuum evaporation apparatus independently comprise an evaporation tank and a temperature control unit; the two vacuum evaporation apparatuses are equipped with a film thickness measuring apparatus;
the conveying apparatus comprises a winding collection apparatus, and preferably, the winding collection apparatus comprises an unwinding roller, a guide roller, a temperature control roller, a heat preservation roller, a cooling roller and a winding roller.

15. The device for the multi-layer lithium metal battery anode according to claim 14, wherein the first vacuum evaporation apparatus and the second vacuum evaporation apparatus independently comprise one evaporation tank and one temperature control unit; preferably, the winding collection apparatus comprises one unwinding roller, three to five guide rollers, three to five temperature control rollers, one heat preservation roller, one cooling roller and one winding roller.

16. The preparation method according to claim 10, wherein in step (1) and step (2), the inert atmosphere is an argon atmosphere.

17. The preparation method according to claim 10, wherein in step (3), the organic solution is a mixed solution of the polymer solid electrolyte with dimethylformamide or N-methylpyrrolidone, and a mass ratio of the polymer solid electrolyte to dimethylformamide or N-methylpyrrolidone is 1:(8-10).

18. The preparation method according to claim 10, wherein in step (3), the ultrasonic dispersion has a time of 1-3 h, preferably, the magnetic stirring has a time of 15-20 h, preferably, the magnetic stirring has a rotating speed of 800-1000 rpm, preferably, the drying has a temperature of 60-90° C., preferably, the drying has a time of 10-30 min.
